(19) United States
(12) Patent Application Publication
(10) Pub. No.: US 2023/0188321 A1
(43) Pub. Date: Jun. 15, 2023

(54) METHOD FOR TRAINING MODEL BASED ON HOMOMORPHIC ENCRYPTION, DEVICE, AND STORAGE MEDIUM

(71) Applicant: Beijing Baidu Netcom Science Technology Co., Ltd., Beijing (CN)

(72) Inventor: Bo JING, Bejiing (CN)

(21) Appl. No.: 18/080,416

(22) Filed: Dec. 13, 2022

(30) Foreign Application Priority Data
Dec. 15, 2021 (CN) 202111528236.9

(51) Int. Cl. H04L 9/00

(52) U.S. Cl. CPC H04L 9/008

(57) ABSTRACT

Provided are a method for training a model based on homomorphic encryption, a device, and a storage medium. The specific implementation is: acquiring homomorphic encrypted data in a model training process; determining a hyperparameter of a model approximation function according to state data present in the model training process, where the model approximation function is used for replacing a model original function involved in the model training process; and inputting the homomorphic encrypted data to the model approximation function for calculation, and performing model training according to a calculation result. Therefore, the application flexibility of functions is improved while achieving the protection of data privacy in the model training process.

### CROSS-REFERENCE TO RELATED APPLICATION(S)

This application claims the priority to Chinese Patent Application No. CN202111528236.9 and filed on Dec. 15, 2021, the disclosure of which is incorporated herein by reference in its entirety.

### TECHNICAL FIELD

The present disclosure relates to the technical field of computer calculation and encryption and, in particular, to the technology of artificial intelligence and deep learning.

### BACKGROUND

With the development of artificial intelligence technology, machine learning has been widely applied in various scenarios.

With the popularization of distributed machine learning, the privacy protection problem in the multi-party joint model training process is raised. In the multi-party joint model training process, the demand for homomorphic encryption of the interactive data and training process is put forward, so as to protect the privacy of data.

However, although the data privacy is protected, the homomorphic encryption technology limits the functions used in machine learning and thus cannot fully support the calculation process of various functions that may be used in the model.

### SUMMARY

The present disclosure provides a method and apparatus for training a model based on homomorphic encryption, a device, and a storage medium, so as to improve both the privacy protection and function application flexibility in the model training process.

According to an aspect of the present disclosure, a method for training a model based on homomorphic encryption is provided. The method includes the steps described below.

Homomorphic encrypted data is acquired in a process of model training.

A hyperparameter of a model approximation function is determined according to state data present in the model training process, where the model approximation function is used for replacing a model original function involved in the model training process.

The homomorphic encrypted data is inputted to the model approximation function for calculation to obtain a calculation result, and model training is performed according to the calculation result.

According to another aspect of the present disclosure, an electronic device is provided. The electronic device includes at least one processor and a memory that is in a communication connection with the at least one processor.

The memory is configured to store instructions executable by the at least one processor, and the instructions are executed by the at least one processor to enable the at least one processor to perform the method for training a model based on homomorphic encryption provided by any of the embodiments of the present disclosure.

According to another aspect of the present disclosure, a non-transitory computer-readable storage medium is further provided. The non-transitory computer-readable storage medium is configured to store computer instructions, and the computer instructions are used for enabling a computer to perform the method for training a model based on homomorphic encryption provided by any of the embodiments of the present disclosure.

According to the technical solutions of the present disclosure, the application flexibility of functions is improved while achieving the protection of data privacy in the model training process.

It is to be understood that the content described herein is not intended to identify key or important features of the embodiments of the present disclosure nor is it intended to limit the scope of the present disclosure. Other features of the present disclosure will be readily understood through the following description.

### BRIEF DESCRIPTION OF DRAWINGS

The drawings are intended to provide a better understanding of the present solution and do not constitute a limitation of the present disclosure. In the drawings:

FIG. 1 is a schematic diagram of a method for training a model based on homomorphic encryption according to an embodiment of the present disclosure;

FIG. 2 is a schematic diagram of a method for training a model based on homomorphic encryption according to an embodiment of the present disclosure;

FIG. 3 is a schematic diagram of an apparatus for training a model based on homomorphic encryption according to an embodiment of the present disclosure; and

FIG. 4 is a block diagram of an electronic device for implementing the method for training a model based on homomorphic encryption according to an embodiment of the present disclosure.

### DETAILED DESCRIPTION

Example embodiments of the present disclosure, including details of the embodiments of the present disclosure, are described hereinafter in conjunction with the drawings to facilitate understanding. The example embodiments are merely illustrative. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

The solutions provided by the embodiments of the present disclosure are described in detail below in conjunction with the drawings.

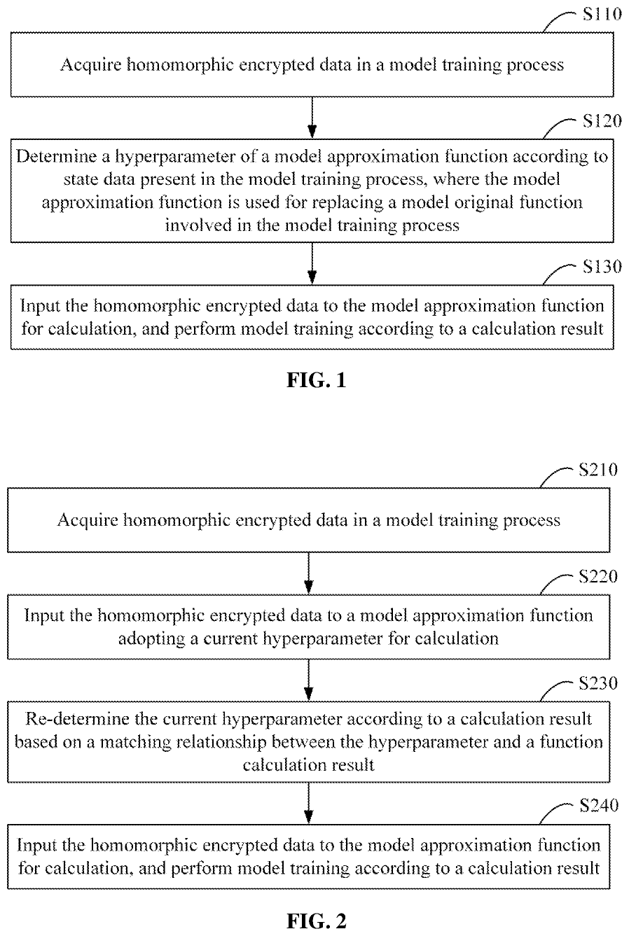

FIG. 1 is a schematic diagram of a method for training a model based on homomorphic encryption according to an embodiment of the present disclosure. The methods for training a model based on homomorphic encryption and the apparatus for training a model based on homomorphic encryption provided by the embodiments of the present disclosure are suitable for the application scenario of model privacy training by the homomorphic encryption technology. The method for training a model based on homomorphic encryption provided by the embodiments of the present disclosure may be executed by the apparatus for training a model based on homomorphic encryption. The apparatus for training a model based on homomorphic encryption is implemented by software and/or hardware and is specifically configured in an electronic device. The electronic device may be a device belonging to any participant in a multi-party joint training scenario and may also be a device of a trusted third party that is capable of performing model training.

With reference to FIG. 1, the method for training a model based on homomorphic encryption specifically includes S110, S120 and S130.

In S110, homomorphic encrypted data is acquired in a model training process.

The homomorphic encrypted data may be the data obtained by encrypting intermediate parameters of the model training using a homomorphic public key. The homomorphic public key may be the public key of any participant in the multi-party joint training scenario and may also be the public key of a trusted third party in the joint training scenario based on the trusted third party, and the homomorphic public key may specifically be determined according to different model training scenarios. The intermediate parameters of the model training may be the intermediate parameters generated after at least two participants of the model training train their respective models based on their respective sample data, and for example, the intermediate parameters may be the parameters required for calculating a loss value and/or a gradient value.

For example, in the model training process in the multi-party joint training scenario, the homomorphic encrypted data may be obtained by any participant that participates in the model training. Specifically, any participant that participates in the model training is taken as a first participant, and another participant other than the first participant is taken as a second participant. The first participant encrypts by using a first homomorphic public key a first intermediate parameter obtained after the first participant trains its own model to obtain first homomorphic encrypted data. The second participant encrypts by using the first homomorphic public key a second intermediate parameter obtained after the second participant trains its own model to obtain second homomorphic encrypted data, where the first homomorphic public key is pre-allocated by the first participant to the second participant. The second participant sends the second homomorphic encrypted data to the first participant so that the first participant obtains the homomorphic encrypted data, where the homomorphic encrypted data includes the first homomorphic encrypted data and the second homomorphic encrypted data.

In S120, a hyperparameter of a model approximation function is determined according to state data present in the model training process, where the model approximation function is used for replacing a model original function involved in the model training process.

The model for training may be a linear model or a neural network model. The linear model may be a logistic regression model, a linear regression model, a variance analysis model or a covariance analysis model. The activation function of forward propagation and the gradient calculation function of backward propagation in the neural network model may be calculated by the approximation method.

The model original function may be a function used for calculating a model key parameter in the model training process. The model key parameter may include a model training condition judgment parameter, an iterative update parameter, a neuron activation parameter and the like. For example, the model training condition judgment parameter may be a calculated loss value, the iterative update parameter may be a calculated gradient value, and the neuron activation parameter may be a calculated neuron activation value. Accordingly, the model original function may include at least one of: a loss function, a gradient calculation function or a neuron activation function of a neural network.

It is to be noted that in the process of training a model based on homomorphic encryption, functions that do not support the calculation of the homomorphic encrypted data exist in the model original function, such as a logarithm function, a power function, a trigonometric function, a piecewise function and the like, and different homomorphic encryption technologies correspond to different types of functions that do not support the calculation. However, most of the model original functions used for model training include at least one function that does not support the calculation of the homomorphic encrypted data. For example, cross-entropy may be used as the loss function of the model in the model training process, the cross-entropy loss function includes a logarithm function and a power function, but neither the logarithm function nor the power function supports the calculation of the homomorphic encrypted data.

The state data may be the calculation state of the model when the model key parameter is calculated in the model training process, for example, the state data may include data such as the calculation result of a model key parameter, a model calculation duration and the number of iterations.

The model approximation function may be a function that supports the calculation of the homomorphic encrypted data and is used for replacing the model original function involved in the model training process, for example, the model approximation function replaces the function that does not support the calculation of the homomorphic encrypted data in the model original function. The model approximation function may include a polynomial.

The hyperparameter may be a parameter that is associated with the model approximation function and that is capable of controlling the model training behavior. The hyperparameter of the model approximation function may include at least one of: an expansion degree of a polynomial, a variable coefficient, and the number of polynomials in a polynomial combination.

For example, in the process of training a linear model, the model approximation function is used for replacing the model original function, where the model original function includes a loss function and a gradient calculation function. For example, the model approximation function may be a polynomial, and the polynomial may be used for replacing a function that cannot perform homomorphic calculation in the loss function and the gradient calculation function, such as a logarithm function and a power function. The state data in the model training process is obtained based on the replaced loss function and gradient function, such as a loss value and a gradient value, and whether the loss value and the gradient value in the model training process are consistent with an expected loss value and an expected gradient value is judged; and the hyperparameter of the model approximation function is updated according to a judgment result, for example, the hyperparameter may include the expansion degree of a polynomial, a variable coefficient and the like. The expected loss value and expected gradient value may be determined according to actual experience and preset in the model before the model training. If the judgment result is that the loss value and gradient value obtained by the model training are inconsistent with the expected loss value and gradient value, a current hyperparameter of the model training may be adjusted, for example, the expansion degree of the polynomial and/or the variable coefficient may be adjusted.

In S130, the homomorphic encrypted data is inputted to the model approximation function for calculation, and model training is performed according to a calculation result.

The homomorphic encrypted data of each participant that participates in the model training may be inputted to the model approximation function for calculation, and the obtained calculation result may be the loss value and the gradient value obtained in the model training process or other related parameters generated in the model training process, such as a neuron activation value. The model training is performed according to the obtained calculation result. Specifically, whether the trained model converges may be judged according to the calculation result, and if the trained model converges, the model training is completed; and if the trained model does not converge, the model training continues to be performed.

In this embodiment of the present disclosure, in the model training process, the homomorphic encrypted data is acquired; the hyperparameter of the model approximation function is determined according to the state data present in the model training process, where the model approximation function is used for replacing the model original function involved in the model training process; and the homomorphic encrypted data is inputted to the model approximation function for calculation, and the model training is performed according to the calculation result. In this solution, the data privacy in the multi-party joint training process is protected by the homomorphic encryption technology, thereby improving the data security in the multi-party model training process. The model original function involved in the model training process is replaced by the model approximation function, thereby removing the limitation of the homomorphic encryption technology on the function used in the model training process, supporting various functions used in the model training process, and achieving both the privacy protection and the application flexibility of functions in the model training process.

On the basis of the embodiments described above, the present disclosure further provides an optional embodiment. In this optional embodiment, the method for training a model based on homomorphic encryption is further described. For details that are not explained in this embodiment, reference may be made to the description of the embodiments described above, and details will not be repeated herein.

With reference to FIG. 2, the method for training a model based on homomorphic encryption includes S210, S220, S230 and S240.

In S210, homomorphic encrypted data is acquired in a model training process.

It is to be noted that the hyperparameter needs to be pre-determined by testing and verification before the model training, and in the actual model training process, the constraints for dynamic changes of the hyper-parameter also need to be pre-determined, that is, the matching relationship between the hyper-parameter and the function calculation result needs to be pre-determined.

In an optional embodiment, before the model training process, the method further includes the determination process of determining the matching relationship between the hyperparameter and the function calculation result, and the determination process includes the following steps: each of at least two groups of homomorphic encrypted data is inputted to a model for test training, where hyperparameters of model approximation functions used in test training of the at least two groups are different; and a hyperparameter of a model approximation function that satisfies a training requirement is selected according to a test training result of each group of homomorphic encrypted data.

At least two groups of homomorphic encrypted data may be taken as test samples to perform test training on the model, where each group of homomorphic encrypted data includes encrypted data from different participants. Each group of homomorphic encrypted data is inputted to the model for test training, and hyperparameters of model approximation functions used in test training of the at least two groups of homomorphic encrypted data may be different. For example, the expansion degrees of polynomials may be different, the variable coefficients may be different, or the number of polynomials in a polynomial combination may be different.

For example, the model original function in a test training model of each group of homomorphic encrypted data may be approximated using polynomials of different hyperparameters. For example, both the model training group A1 and the model training group A2 use the polynomial B to approximate the model original function b, but the hyperparameter corresponding to the polynomial b used by the model training group A1 may be c1, and the hyperparameter corresponding to the polynomial b used by the model training group A2 may be c2.

For example, the test training model of each group of homomorphic encrypted data may use a combination of multiple polynomials to approximate the model original function, and the hyperparameters corresponding to the multiple polynomials may be the same or different. For example, when the model original function is a piecewise function with two segments, each piece in the piecewise function with two segments may be approximated using polynomials with the same hyperparameter or polynomials with different hyperparameters. For example, both the model training group B1 and the model training group B2 use a combination of multiple polynomials b to approximate the model original function, but the number of the multiple polynomials b corresponding to the model training group B1 and the number of the multiple polynomials b corresponding to the model training group B2 may be the same or different, and the hyperparameters of the multiple polynomials b corresponding to the model training group B1 and the hyperparameters of the multiple polynomials b corresponding to the model training group B2 may be the same or different.

The hyperparameter of a model approximation function that satisfies a training requirement is selected according to the test training result of each group of homomorphic encrypted data. The test training result of each group of homomorphic encrypted data may include a loss value and a gradient value obtained from the test training. For example, a numerical grid corresponding to the loss value and the gradient value may be determined according to the loss value and the gradient value obtained from the training of each group of homomorphic encrypted data, that is, different corresponding value ranges; and the association relationship between the hyperparameter of the model approximation function of each group of homomorphic encrypted data and the numerical grid corresponding to the loss value and the gradient value is established so that the matching relationship between the hyperparameter and the calculation result is pre-determined before the model training, that is, in the subsequent model training process, when the calculation result of the function is located in different numerical grids, the pre-determined hyperparameter associated with the grid may be switched to. The numerical grid may be a one-dimensional grid or a multi-dimensional grid and may specifically be determined according to the number of model training parameters.

In a specific example, three groups of homomorphic encrypted data are taken as test samples to perform test training on the model, and three groups of homomorphic encrypted data are inputted to the model, which are recorded as the test training group A, the test training group B and the test training group C. The hyperparameters corresponding to the test training group A, the test training group B and the test training group C are different from each other. If the loss value calculated using the test training group A is in the numerical grid 1, the hyperparameter of the test training group A is associated with the numerical grid 1; if the loss value calculated using the test training group B is in the numerical grid 2, the hyperparameter of the test training group B is associated with the numerical grid 2; and if the loss value calculated by using the test training group C is in the numerical grid 3, the hyperparameter of the test training group C is associated with the numerical grid 3. The association relationship between the hyperparameter obtained from the test training and the training result is pre-stored in the training model before the model training so that in the subsequent model training process, the hyperparameter in the model training may be dynamically changed according to the pre-stored association relationship between the hyperparameter obtained from the test training and the training result, so as to achieve the optimal model training result.

In this optional embodiment, each of at least two groups of homomorphic encrypted data are inputted to the model for test training, where the hyperparameters of the model approximation functions used in test training of the at least two groups of homomorphic encrypted data are different; and the hyperparameter of a model approximation function that satisfies the training requirement is selected according to the test training result of each group of homomorphic encrypted data. In this solution, the matching relationship between the hyperparameter and the function calculation result is pre-determined before the model training so that the hyperparameter can be dynamically changed according to the matching relationship in the subsequent model training process, so as to achieve the optimal model training effect.

In S220, the homomorphic encrypted data is inputted to a model approximation function adopting a current hyperparameter for calculation.

The current hyperparameter of the model approximation function may be a preset initial hyperparameter before the model training starts, where the expansion degree of the polynomial of the initial hyperparameter may be 1, the variable coefficient may be 1, and the number of polynomials in the polynomial combination may be 1. The initial hyperparameter of the model approximation function may be determined by relevant technicians according to actual experience values or may be determined through a large number of experimental values verified by tests before the model training starts. Before the model training starts, the determined initial hyperparameter needs to be pre-stored in a training model so that a preset initial hyperparameter may be used as the current hyperparameter of the model approximation function to calculate the inputted homomorphic encrypted data when the model training starts.

In the model training process, the homomorphic encrypted data may always be calculated using the model approximation function of the current hyperparameter. In order to ensure the accuracy of model training and improve the efficiency of model training, the current hyperparameter may be dynamically changed in the model training process so that a more accurate super-parameter may be used in each iterative training in the model training process.

In S230, the current hyperparameter is re-determined according to a calculation result based on a matching relationship between the hyperparameter and a function calculation result.

The calculation result may include the calculated loss value and gradient value. The matching relationship between the hyperparameter and the function calculation result may be pre-determined according to actual experience. For example, the matching relationship between different hyperparameters and the value ranges corresponding to the loss value and the gradient value may be pre-determined according to actual experience, for example, the value range corresponding to the loss value obtained by training based on the hyperparameter a1 is (0, 100], and the value range corresponding to the loss value obtained by training based on the hyperparameter a2 is (100, 500]. The matching relationship between different hyperparameters and the value range corresponding to the gradient value is determined in a manner similar to the manner described above, and details will not be repeated herein.

For example, in order to improve the accuracy and efficiency of model training, the matching relationship between the hyper parameter and the function calculation result may be pre-determined by the above-mentioned test verification manner.

In an optional embodiment, the step where the current hyperparameter is re-determined according to a calculation result based on a matching relationship between the hyperparameter and a function calculation result includes: a hyperparameter corresponding to a value range in which the calculation result falls is acquired according to the value range, and the hyperparameter is determined as a current hyperparameter.

For example, according to a value range in which the loss value and the gradient value obtained in each iterative training fall in the model training process, a hyperparameter corresponding to the value range is obtained, and the hyperparameter is used as the current hyperparameter to continue training the model until the loss value and the gradient value satisfy a model training termination condition, where the model training termination condition may be that a model error rate is less than a set error threshold, for example, the error threshold may be ±5%.

For example, when model training starts, a preset initial hyperparameter is used as the current hyperparameter for model training at the start of model training; a calculation result based on the initial hyperparameter is obtained after model iterative training, for example, the loss value and gradient value are obtained, and the value range in which the calculation result falls is determined; the current hyperparameter is re-determined according to the matching relationship between the pre-determined hyperparameter and the calculation result, and the model training is continued according to the re-determined current hyperparameter until the model training termination condition is satisfied.

In this optional embodiment, the hyperparameter corresponding to the value range in which the calculation result falls is obtained according to the value range and the obtained hyperparameter is determined as the current hyperparameter so that the hyperparameter is dynamically determined in the model training process and the model is continuously optimized according to the dynamic determination result, thereby further improving the accuracy of the model training.

In S240, the homomorphic encrypted data is inputted to the model approximation function for calculation, and model training is performed according to a calculation result.

It is to be noted that in addition to the value range in which the calculation result falls, the hyperparameter in the model training process may be determined based on other conditions, for example, the hyperparameter may be dynamically changed according to the conditions such as the calculation duration of each round of calculation and the number of iterations in the model training process.

In an optional embodiment, the state data may also include a calculation duration of the current round of calculation; accordingly, the step where a hyperparameter of a model approximation function is determined according to state data present in the model training process includes: if the calculation duration of the current round of calculation in the model training process satisfies a duration condition, a candidate hyperparameter whose accuracy priority is lower than the accuracy priority of the current hyperparameter is determined to replace the current hyperparameter.

The duration condition may be preset by relevant technicians according to the model calculation amount, the training data scale and the selected running speed of the processor. For example, the duration condition may be that the calculation duration of the current round of calculation is longer than a duration threshold, where the duration threshold may be 5 hours. The accuracy priority of the hyperparameter may be pre-determined before the model training. For example, a hyperparameter having a lower expansion degree of the polynomial may be set to hyperparameter having a lower priority, and a hyperparameter having a higher expansion degree of the polynomial may be set to hyperparameter having a higher priority. The association relationship between the hyperparameter and the accuracy priority may be pre-stored in the model so that the hyperparameter may be dynamically determined according to the calculation duration and the priority relationship in the model training process.

For example, in the model training process, if the calculation duration of the current round of calculation exceeds a preset duration threshold, for example, the calculation duration exceeds 5 hours, it can be considered that the accuracy of the current hyperparameter is high, resulting in the failure of the calculation of the model; and a candidate hyperparameter whose accuracy priority is lower than the accuracy priority of current hyperparameter may be determined according to the pre-set association relationship between the hyperparameter and the accuracy priority, and the candidate hyperparameter may be used to replace the current hyperparameter to continue the model training.

In this optional embodiment, whether the calculation duration of the current round of calculation in the model training process satisfies the duration condition is judged, and if the calculation duration of the current round of calculation in the model training process satisfies the duration condition, the candidate hyperparameter whose accuracy priority is lower than the accuracy priority of the current hyperparameter is determined to replace the current hyperparameter. In this solution, in the process of model training, when the calculation duration of the model is long, the hyperparameter may be dynamically determined according to the accuracy priority so that the purpose of dynamically coping with a series of state changes in the model training process is achieved, for example, the calculation duration is long, thereby improving the flexibility of the model training process.

In an optional embodiment, the state data may also include the number of calculation iterations of the current round of calculation; accordingly, the step where a hyperparameter of a model approximation function is determined according to state data present in the model training process includes: if the number of calculation iterations in the model training process satisfies a number condition, a candidate hyperparameter whose accuracy priority is higher than the accuracy priority of the current hyperparameter is determined to replace the current hyperparameter.

The number condition may be preset by relevant technicians according to the model calculation amount and the training data scale. For example, the number condition may be that the number of calculation iterations in the model training process is greater than an iteration number threshold, where the iteration number threshold may be 50 times.

For example, if the number of calculation iterations satisfies the number condition in the model training process, for example, if 50 model iterative training has been completed, when the model has not converged after 50 model iterative training or the calculated loss value and gradient value do not satisfy the expected standard, then it can be considered that the accuracy of the current hyperparameter of the current trained model is low so that the model training cannot achieve the expected effect. In this manner, a hyperparameter with high accuracy may be used for model training. Specifically, a candidate hyperparameter whose accuracy priority is higher than the accuracy priority of the current hyperparameter may be determined according to the association relationship between the preset hyperparameter and the accuracy priority, and the candidate hyperparameter may be used to replace the current hyperparameter to continue the model training. For example, a polynomial with higher accuracy may be selected for calculation.

In this optional embodiment, whether the calculation duration of the current round of calculation in the model training process satisfies the duration condition is judged, and if the calculation duration of the current round of calculation in the model training process satisfies the duration condition, the candidate hyperparameter whose accuracy priority is lower than the accuracy priority of the current hyperparameter is determined to replace the current hyperparameter. In this solution, in the process of model training, when the number of model iterations is large, the hyperparameter may be dynamically determined according to the accuracy priority, thereby improving the efficiency of model training and the flexibility of the model training process.

In this embodiment of the present disclosure, the homomorphic encrypted data is inputted to a model approximation function adopting a current hyperparameter for calculation; and, the current hyperparameter is re-determined according to a calculation result based on the matching relationship between the hyperparameter and the function calculation result. In this solution, in the model training process, the dynamic change of the hyperparameter in the model training process is achieved according to the matching relationship between the hyperparameter and the function calculation result. According to the dynamic change of the hyperparameter, the trained model is continuously optimized in the model training process, thereby achieving the optimal model training result and improving both the efficiency and the accuracy of the model training.

On the basis of the technical solutions described above, the embodiments of the present disclosure also provide a preferred embodiment of the method for training a model based on homomorphic encryption, where the trained model is a distributed model, the homomorphic encrypted data is a homomorphic encrypted intermediate parameter for interaction between multiple model participants in the model training process, and this embodiment is described below by using two participants as examples.

It is assumed that there are two participants that participate in the model training, that is, the participant A (sample data is unlabeled) and the participant B (sample data is labeled). The model original function in the model of the participant A and the participant B includes a loss function and a gradient function.

The loss function adopts the cross-entropy loss function, and the calculation formula of the cross-entropy may be expressed as:

$$J ( θ ) = \frac{- 1}{m * CostSum ( {h}_{θ} ( x ( j ) ) , y ( j ) )} .$$

In the above formula, CostSum(h_{θ}(x(j)), y(j)) is a loss summation function and may be determined using the following manner

| for j = 0; j + +; j < m | |
|---|---|
| { | |
| CostSum(h_{θ}(x(j)),y(j)) += y(j) *log(h_{θ}(x(j))) + (1 *log(1 | |
| − y(j)) − h_{θ}(x(j)) | |
| } | . |

m is the total sample number of model training samples, and j is the sample serial number of model training samples; y(j) is the label value of the j sample, and the value of y(j) is 0 or 1; x(j) is the characteristic sequence of the j sample, and h_{θ}(x(j)) is the logistic regression function of x(j); θ represents the characteristic parameter of the model training, and n is the number of characteristic parameters to be trained in the model.

As can be seen from the calculation formula of the loss function, the loss function includes a logarithm function and a power function, and these two kinds of functions cannot be supported by homomorphic encryption calculation. Therefore, the logarithm function and the power function need to be pre-replaced with a model approximation function, for example, a polynomial is used as the model approximation function to replace the two functions, so as to obtain the support of homomorphic encryption calculation.

Optionally, Taylor expansion may be used to approximate a smooth function to achieve polynomial approximation. The smooth function may include a logarithm function, a power function, a trigonometric function and the like. The higher the degree of polynomial expansion terms, the higher the training accuracy of the model. As can be seen through a large number of model training test results, the expansion to the quadratic term, cubic term or quartic term can satisfy the common training accuracy requirements, and the model calculation amount is not too high. The following is described by using an example where the polynomial expansion term is a quadratic term.

The multivariate x(j) of h_{θ}(x(j)) is one x and then may be represented by a sigmoid function:

$${h}_{θ} ( x ) = \frac{1}{1 + {e}^{- x}} .$$

log(h_{θ}(x)) in the loss function is derived:

$$log ( {h}_{θ} ( x ) ) = ln ( \frac{1}{1 + {e}^{- x}} ) .$$

log(h_{θ}(x)) is taken as f(x), and f(x) is subjected to first derivation:

$${f}^{′} ( x ) = {( ln ( \frac{1}{1 + {e}^{- x}} ) )}^{′}$$

$${f}^{′} ( x ) = \frac{{e}^{- x}}{1 + {e}^{- x}} .$$

f(x) is subjected to second derivation:

$${f}^{″} ( x ) = {( \frac{{e}^{- x}}{1 + {e}^{- x}} )}^{′} = \frac{- {e}^{- x}}{1 + {e}^{- x}} + \frac{{e}^{- 2 x}}{{( 1 + {e}^{- x} )}^{2}}$$

$$f ( 0 ) = ln ( 0.5 ) , {f}^{′} ( 0 ) = 0.5 , {f}^{″} ( 0 ) = - 0.25 .$$

Therefore, the quadratic polynomial of log(h_{θ}(x)) in the loss function after Taylor expansion is:

$$f ( x ) = f ( 0 ) + {f}^{′} ( 0 ) ( x ) + \frac{{f}^{″} ( 0 ) ( {x}^{2} )}{2} = ln ( 0.5 ) + \frac{x}{2} - \frac{{x}^{2}}{8} .$$

log(1−h_{θ}(x))) in the loss function is derived:

$$log ( 1 - {h}_{θ} ( x ) ) = ln ( 1 - \frac{1}{1 + {e}^{- x}} ) .$$

g(x) is subjected to second derivation:

$${g}^{″} ( x ) = {( - \frac{1}{1 + {e}^{- x}} )}^{′} = - \frac{{e}^{- x}}{{( 1 + {e}^{- x} )}^{2}}$$

$$g ( 0 ) = ln ( 0.5 ) , {g}^{′} ( 0 ) = - 0.5 , {f}^{″} ( 0 ) = - 0.25 .$$

Therefore, the quadratic polynomial of log(1−h_{θ}(x)) in the loss function after Taylor expansion is:

$$g ( x ) = g ( 0 ) + g ( 0 ) ( x ) + \frac{{g}^{″} ( 0 ) ( {x}^{2} )}{2} = ln ( 0.5 ) - \frac{x}{2} - \frac{{x}^{2}}{8} .$$

The loss function obtained after the logarithm function in the loss function is replaced with the above-mentioned quadratic polynomials is:

$$\begin{matrix}Cost = y log ( {h}_{θ} ( x ) ) + ( 1 - y ( j ) ) * log ( 1 - {h}_{θ} ( x ) \\ = y * ( ln ( 0.5 ) + \frac{x}{2} - \frac{{x}^{2}}{8} ) + ( 1 - y ) ln ( 0.5 ) - \frac{x}{2} - \frac{{x}^{2}}{8} \\ = ln ( 0.5 ) + ( y - 0.5 ) * x - \frac{{x}^{2}}{8} .\end{matrix}$$

The parameters of each participant of model training are linear accumulated, and the following is described by using two participants as examples. The linear accumulated value of the characteristic parameter of model training of the first participant A is preValA, and preValA=θ₁(0)+θ₁(1)*x(1)+θ₁(2)*x(2)+ . . . +θ₁(n)·x(n), where θ₁ is the characteristic parameter of model training of the first participant. The linear accumulated value of the characteristic parameter of model training of the second participant B is preValB, and preValB=θ₂(0)+θ₂(1)*x(1)+θ₂(2)*x(2)+ . . . +θ₂(n)*x(n), where θ₂ is the characteristic parameter of model training of the second participant.

PreValA and preValB are inputted to the loss function Cost to obtain the Cost calculation formula:

$$Cost = ln ( 0.5 ) + ( y - 0.5 ) * ( preValA + preValB ) - \frac{{( preValA + preValB )}^{2}}{8}$$

$$Cost = ln ( 0.5 ) + ( y - 0.5 ) * preValA + ( y - 0.5 ) * preValB - \frac{{( preValA )}^{2}}{8} - \frac{{( preValB )}^{2}}{8} - \frac{preValA * preValB}{4} .$$

In the above formula, the first intermediate parameter of the participant A includes (y−0.5), (y−0.5)*preValA,

$$\frac{{( preValA )}^{2}}{8} and \frac{preValA}{4} ,$$

and the second intermediate parameter of the participant B includes (y−0.5), (y−0.5)*preValB,

$$\frac{{( preValB )}^{2}}{8} and \frac{preValB}{4} .$$

The participant A evaluates the loss through the loss function in the following manner.

The participant B uses its own homomorphic public key to encrypt data to obtain second homomorphic encrypted data, where the second homomorphic encrypted data includes encByB(y−0.5), encByB((y−0.5)*preValB),

$$encByB ( \frac{{( preValB )}^{2}}{8} ) and encByB ( \frac{preValB}{4} ) .$$

The participant B sends the second homomorphic encrypted data to the participant A, and the participant A executes the homomorphic operation using the pre-obtained homomorphic public key of the participant B. The operation result is as follows:

$$CostA = ln ( 0.5 ) + encByB ( y - 0.5 ) * preValA + encByB ( ( y - 0.5 ) * preValB ) - \frac{{( preValA )}^{2}}{8} - encByB ( \frac{{( preValB )}^{2}}{8} ) - preValA * encByB ( \frac{preValB}{4} ) + ranNumA .$$

In the above formula, ranNumA is a first random number. The participant A sends the operation result of CostA to the participant B.

The participant B uses its own homomorphic public key to decrypt the operation result of CostA and sends the decrypted result to the participant A as a second key parameter. The participant A receives the result obtained after the participant B decrypts CostA, that is, the second key parameter, removes the first random number ranNumA from the second key parameter, obtains the final calculation result as the final calculation result of the loss value of the participant A, and updates the gradient value of the participant A using the finally obtained loss value.

The participant B evaluates the loss through the loss function in the following manner.

The participant A uses its own homomorphic public key to encrypt data to obtain first homomorphic encrypted data, where the first homomorphic encrypted data includes encByA(y−0.5), encByA((y−0.5)*preValB),

$$encByA ( \frac{{( preValA )}^{2}}{8} ) and encByA ( \frac{preValA}{4} ) .$$

The participant A sends the first homomorphic encrypted data to the participant B, and the participant B executes the homomorphic operation using the pre-obtained homomorphic public key of the participant A. The operation result is as follows:

$$CostB = ln ( 0.5 ) + encByA ( y - 0.5 ) * preValB + encByA ( ( y - 0.5 ) * preValA ) - \frac{{( preValB )}^{2}}{8} - encByA ( \frac{{( preValA )}^{2}}{8} ) - preValB * encByA ( \frac{preValA}{4} ) + ranNumB .$$

In the above formula, ranNumB is a second random number. The participant B sends the operation result of CostB to the participant A.

The participant A uses its own homomorphic public key to decrypt the operation result of CostB and sends the decrypted result to the participant B as a first key parameter. The participant B receives the result obtained after the participant A decrypts CostB, that is, the first key parameter, removes the second random number ranNumB from the first key parameter, obtains the final calculation result as the final calculation result of the loss value of the participant B, and updates the gradient value of the participant B using the finally obtained loss value.

Through the above manner, the participant A and the participant B judge whether the oscillation amplitudes of the last two loss function difference evaluations satisfy the target requirements, and determine whether to perform the convergence operation of gradient descent according to the loss function difference evaluation result.

The calculation of the gradient function is as follows:

| for i = 0; i + +; i < n | |
|---|---|
| { | |
| θ(i) = θ(i) − aGrad(i) | |
| } | . |

Grad(i) of the i^{th} characteristic is:

```
for i = 0; i + +; i < n
{
  Grad(i) = (predictValue(j) − realValue(j))*trainSet[j][i]
}
    predictValue (j) = h_{θ} (x(j))
${h}_{θ} ( x ( j ) ) = \frac{1}{1 + {e}^{- ( {w}^{′} x )}} = \frac{1}{1 + {e}^{- ( θ ( 0 ) + θ ( 1 ) * x ( 1 ) + θ ( 2 ) * x ( 2 ) + … + θ ( n ) * x ( n ) )}}$
    $Grad ( i ) = \frac{Grad ( i )}{m} .$
```

Similarly, the calculation of predictValue(j) also needs to be completed with the cooperation of multiple parties, where a is abbreviation of alpha, represents a learning rate and is a numerical value.

If the decentralized calculation gradient wants to be completed, the core is the calculation of h_{θ}(x(j)) is completed by homomorphic encryption, but similarly, the exponential function based on e also does not support homomorphic calculation. Therefore, the core function h_{θ}(x(j)) needs to be subjected to Taylor expansion, and the following is described by using Taylor expansion to a quadratic term as an example.

The multivariate x(j) of h_{θ}(x(j)) is one x and then may be represented by a sigmoid function:

$${h}_{θ} ( x ) = \frac{1}{1 + {e}^{- x}} .$$

h_{θ}(x) is taken as h(x), and h(x) is subjected to first derivation:

$${h}^{′} ( x ) = {( \frac{1}{1 + {e}^{- x}} )}^{′}$$

$${h}^{′} ( x ) = \frac{{e}^{- x}}{{( 1 + {e}^{- x} )}^{2}} .$$

f(x) is subjected to second derivation:

$${h}^{″} ( x ) = {( \frac{{e}^{- x}}{{( 1 + {e}^{- x} )}^{2}} )}^{′} = \frac{- {e}^{- x}}{{( 1 + {e}^{- x} )}^{2}} + \frac{2 {e}^{- 2 x}}{{( 1 + {e}^{- x} )}^{3}}$$

$$h ( 0 ) = 0.5 , {h}^{′} ( 0 ) = 0.25 , {f}^{″} ( 0 ) = 0.$$

Therefore, the result of the quadratic term of h_{θ}(x) after Taylor expansion is:

$$h ( x ) = h ( 0 ) + {h}^{′} ( 0 ) ( x ) + \frac{{h}^{″} ( 0 ) ( {x}^{2} )}{2} = 0.5 + \frac{x}{4} .$$

The calculation of the gradient function is as follows:

$$Grad ( i ) = ( predictValue ( j ) - realValue ( j ) ) * trainSet [ j ] [ i ] = ( 0.5 + \frac{x}{4} - y ) * x ( i ) = ( 0.5 + \frac{preValA + preValB}{4} - y ) * x ( i ) = x ( i ) * \frac{preValA}{4} + x ( i ) * ( 0.5 + \frac{PreValB}{4} - y ) .$$

The gradient calculation process of the local characteristic of the participant A is as follows:

The participant B uses its own homomorphic public key to encrypt data to obtain third homomorphic encrypted data, where the third homomorphic encrypted data includes

$$encByB ( 0.5 + \frac{PreValB}{4} - y ) .$$

The participant B sends the third homomorphic encrypted data to the participant A, and the participant A executes the homomorphic operation using the pre-obtained homomorphic public key of the participant B. The operation result is as follows:

$$Grad ( i ) = x ( i ) * \frac{preValA}{4} + x ( i ) * encByB ( 0.5 + \frac{PreValB}{4} - y ) + ranNumA .$$

In the above formula, ranNumA is a first random number. The participant A sends the operation result of GradA(i) to the participant B.

The participant B uses its own homomorphic public key to decrypt the operation result of GradA(i) and sends the decrypted result to the participant A as a third key parameter. The participant A receives the result obtained after the participant B decrypts GradA(i), that is, the third key parameter, removes the first random number ranNumA from the third key parameter, and obtains the final calculation result as the updated gradient value of the participant A.

The gradient calculation process of the local characteristic of the participant B is as follows:

The participant A uses its own homomorphic public key to encrypt data to obtain fourth homomorphic encrypted data, where the fourth homomorphic encrypted data includes

$$encByB ( \frac{PreValB}{4} ) .$$

The participant A sends the fourth homomorphic encrypted data to the participant B, and the participant B executes the homomorphic operation using the pre-obtained homomorphic public key of the participant A. The operation result is as follows:

$$GradB ( i ) = x ( i ) * encByA ( \frac{preValA}{4} ) + x ( i ) * ( 0.5 + \frac{PreValB}{4} - y ) + ranNumB .$$

In the above formula, ranNumB is a second random number. The participant B sends the operation result of GradB(i) to the participant A.

The participant A uses its own homomorphic public key to decrypt the operation result of GradB(i) and sends the decrypted result to the participant B as a fourth key parameter. The participant B receives the result obtained after the participant A decrypts GradB(i), that is, the fourth key parameter, removes the second random number ranNumB from the fourth key parameter, and obtains the final calculation result as the updated gradient value of the participant B.

Through the solutions described above, the distributed model training in which multiple parties participate is completed. It is to be noted that the solutions described above only illustrate the process of two participants participating in model training, and in fact, the distributed model training may be performed with the cooperation of multiple participants, for example, there may be more than three participants.

In another optional embodiment, sample data of each participant may also be obtained by a feasible third party for model training, each participant sends its own homomorphic encrypted data to a trusted third party, and the trusted third party may perform model training using the method provided by the embodiments described above. Details will not be repeated herein.

As the implementation of the preceding method for training a model based on homomorphic encryption, the present disclosure further provides an optional embodiment of an apparatus for performing the method for training a model based on homomorphic encryption. The apparatus may be implemented in software and/or hardware and is specifically configured in an electronic device.

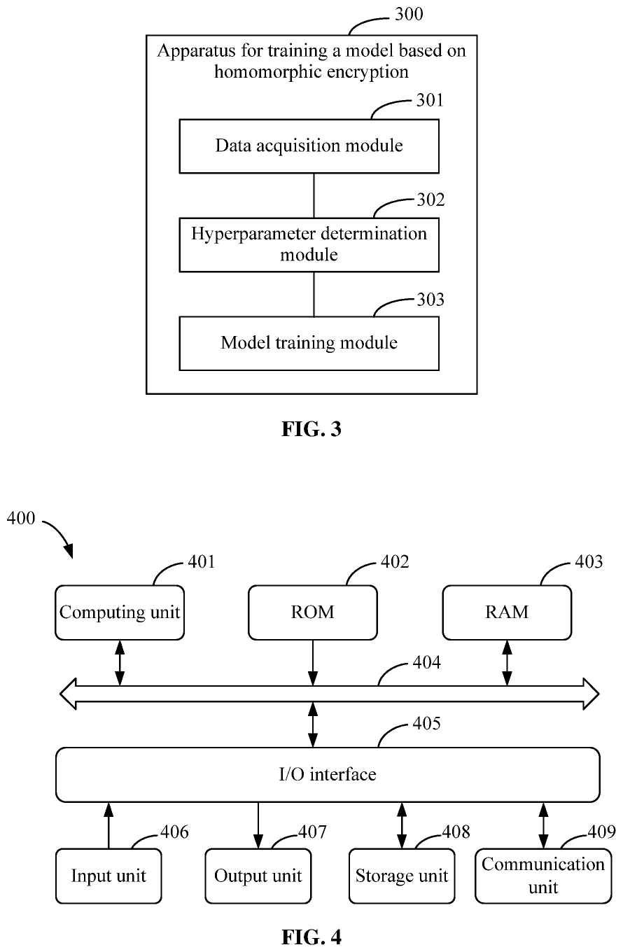

Further, with reference to FIG. 3, the apparatus 300 for training a model based on homomorphic encryption includes a data acquisition module 301, a hyperparameter determination module 302 and a model training module 303.

The data acquisition module 301 is configured to acquire homomorphic encrypted data in a model training process.

The hyperparameter determination module 302 is configured to determine a hyperparameter of a model approximation function according to state data present in the model training process, where the model approximation function is used for replacing a model original function involved in the model training process.

The model training module 303 is configured to input the homomorphic encrypted data to the model approximation function for calculation and perform model training according to a calculation result.

In this embodiment of the present disclosure, in the model training process, the homomorphic encrypted data is acquired; the hyperparameter of the model approximation function is determined according to the state data present in the model training process, where the model approximation function is used for replacing the model original function involved in the model training process; and the homomorphic encrypted data is inputted into the model approximation function for calculation, and the model training is performed according to the calculation result. In this solution, the data privacy in the multi-party joint training process is protected by the homomorphic encryption technology, thereby improving the data security in the multi-party model training process. The model original function involved in the model training process is replaced by the model approximation function, thereby removing the limitation of the homomorphic encryption technology on the function used in the model training process, supporting various functions used in the model training process, and achieving both the privacy protection and the application flexibility of functions in the model training process.

In an optional embodiment, the model original function includes at least one of: a loss function, a gradient calculation function or a neuron activation function of a neural network.

In an optional embodiment, the model original function includes at least one of: a logarithm function, a power function, a trigonometric function or a piecewise function.

In an optional embodiment, the model approximation function includes a polynomial.

In an optional embodiment, the hyperparameter of the model approximation function includes at least one of: an expansion degree of a polynomial, a variable coefficient, and the number of polynomials in a polynomial combination.

In an optional embodiment, the model is a linear model or a neural network model.

In an optional embodiment, the hyperparameter determination module 302 includes a data calculation unit and a hyperparameter determination unit.

The data calculation unit is configured to input the homomorphic encrypted data into a model approximation function adopting a current hyperparameter for calculation.

The hyperparameter determination unit is configured to re-determine, based on a matching relationship between the hyperparameter and a function calculation result, the current hyperparameter according to a calculation result.

In an optional embodiment, the hyperparameter determination unit includes a hyperparameter determination sub-unit.

The hyperparameter determination sub-unit is configured to acquire, according to a value range in which the calculation result falls, a hyperparameter corresponding to the value range, and determine the hyperparameter as a current hyperparameter.

In an optional embodiment, the apparatus further includes a matching relationship determination module.

The matching relationship determination module is configured to determine a matching relationship between the hyperparameter and a function calculation result.

The matching relationship determination module includes a test training unit and a hyperparameter selection unit.

The test training unit is configured to input each of at least two groups of homomorphic encrypted data to a model for test training, where the hyperparameters of the model approximation functions used in test training of the at least two groups of homomorphic encrypted data are different.

The hyperparameter selection unit is configured to select a hyperparameter of a model approximation function that satisfies a training requirement according to the test training result of each group of homomorphic encrypted data.

In an optional embodiment, the state data includes a calculation duration of a current round of calculation and/or the number of calculation iterations.

In an optional embodiment, the hyperparameter determination module 302 includes a first current hyperparameter determination unit.

The first current hyperparameter determination unit is configured to, if the calculation duration of the current round of calculation in the model training process satisfies a duration condition, determine a candidate hyperparameter whose accuracy priority is lower than an accuracy priority of the current hyperparameter to replace the current hyperparameter.

In an optional embodiment, the hyperparameter determination module 302 includes a second current hyperparameter determination unit.

The second current hyperparameter determination unit is configured to, if the number of calculation iterations in the model training process satisfies a number condition, determine a candidate hyperparameter whose accuracy priority is higher than an accuracy priority of the current hyperparameter to replace the current hyperparameter.

In an optional embodiment, the model is a distributed model, and the homomorphic encrypted data is a homomorphic encrypted intermediate parameter for interaction between multiple model participants in the model training process.

The apparatus for training a model based on homomorphic encryption may perform the method for training a model based on homomorphic encryption provided by any of the embodiments of the present disclosure and has function modules and beneficial effects corresponding to the performed method for training a model based on homomorphic encryption.

In the technical solutions of the present disclosure, acquisition, storage and application of homomorphic encrypted data involved herein are in compliance with relevant laws and regulations and do not violate the public order and good customs.

According to an embodiment of the present disclosure, the present disclosure further provides an electronic device, a readable storage medium and a computer program product.

FIG. 4 is a block diagram of an example electronic device 400 for implementing the embodiments of the present disclosure. The electronic device is intended to represent various forms of digital computer, for example, a laptop computer, a desktop computer, a worktable, a personal digital assistant, a server, a blade server, a mainframe computer or another applicable computer. The electronic device may also represent various forms of mobile device, for example, a personal digital assistant, a cellphone, a smartphone, a wearable device or another similar computing device. Herein the shown components, the connections and relationships between these components, and the functions of these components are illustrative only and are not intended to limit the implementation of the present disclosure as described and/or claimed herein.

As shown in FIG. 4, the device 400 includes a computing unit 401. The computing unit 401 may perform various types of appropriate operations and processing based on a computer program stored in a read-only memory (ROM) 402 or a computer program loaded from a storage unit 408 to a random-access memory (RAM) 403. Various programs and data required for operations of the device 400 may also be stored in the RAM 403. The computing unit 401, the ROM 402 and the RAM 403 are connected to each other via a bus 404. An input/output (I/O) interface 405 is also connected to the bus 404.

Multiple components in the device 400 are connected to the I/O interface 405. The multiple components include an input unit 406 such as a keyboard and a mouse, an output unit 407 such as various types of displays and speakers, the storage unit 408 such as a magnetic disk and an optical disk, and a communication unit 409 such as a network card, a modem and a wireless communication transceiver. The communication unit 409 allows the device 400 to exchange information/data with other devices over a computer network such as the Internet and/or various telecommunications networks.

The computing unit 401 may be various general-purpose and/or special-purpose processing components having processing and computing capabilities. Some examples of the computing unit 401 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 401 executes various methods and processing described above, such as the method for training a model based on homomorphic encryption. For example, in some embodiments, the method for training a model based on homomorphic encryption may be implemented as a computer software program tangibly contained in a machine-readable medium such as the storage unit 408. In some embodiments, part or all of a computer program may be loaded and/or installed on the device 400 via the ROM 402 and/or the communication unit 409. When the computer programs are loaded into the RAM 403 and executed by the computing unit 401, one or more steps of the above method for training a model based on homomorphic encryption may be performed. Alternatively, in other embodiments, the computing unit 401 may be configured, in any other suitable manner (for example, by means of firmware), to execute the method for training a model based on homomorphic encryption.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on a chip (SoCs), complex programmable logic devices (CPLDs), computer hardware, firmware, software and/or combinations thereof. The embodiments may include implementations in one or more computer programs. The one or more computer programs are executable, interpretable, or executable and interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

Program codes for implementing the methods of the present disclosure may be compiled in any combination of one or more programming languages. These program codes may be provided for a processor or controller of a general-purpose computer, a special-purpose computer or another programmable data processing device such that the program codes, when executed by the processor or controller, cause functions/operations specified in the flowcharts and/or block diagrams to be implemented. The program codes may be executed in whole on a machine, executed in part on a machine, executed, as a stand-alone software package, in part on a machine and in part on a remote machine, or executed in whole on a remote machine or a server.

In the context of the present disclosure, the machine-readable medium may be a tangible medium that may include or store a program that is used by or used in conjunction with a system, apparatus or device that executes instructions. The machine-readable medium may be a machine-readable signal medium or a machine-readable storage medium. The machine-readable medium may include, but is not limited to, electronic, magnetic, optical, electromagnetic, infrared or semiconductor systems, apparatuses or devices or any suitable combinations thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of devices may also be used for providing interaction with a user. For example, feedback provided for the user can be sensory feedback in any form (for example, visual feedback, auditory feedback or haptic feedback). Moreover, input from the user can be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in the service of a related physical host and a related virtual private server (VPS). The server may also be a server of a distributed system or a server combined with blockchain.

Artificial intelligence is the study of making computers simulate certain thinking processes and intelligent behaviors (such as learning, reasoning, thinking, planning, and the like) of humans, both at the hardware and software level. The artificial intelligence hardware technologies generally include technologies such as sensors, special artificial intelligence chips, cloud computing, distributed storage, big data processing, and the like. The artificial intelligence software technologies mainly include computer vision technology, speech recognition technology, natural language processing technology, machine learning/deep learning technology, big data processing technology, knowledge map technology, and the like.

Cloud computing refers to a technical system that accesses flexible and scalable shared physical or virtual resource pools through the network, where resources can include servers, operating systems, networks, software, applications and storage devices, and deploys and manages resources on demand and in a self-service manner. The cloud computing technology can provide efficient and powerful data processing capabilities for artificial intelligence, blockchain and other technology applications and model training.

It is to be understood that various forms of the preceding flows may be used, with steps reordered, added or removed. For example, the steps described in the present disclosure may be executed in parallel, in sequence or in a different order as long as the desired result of the technical solution disclosed in the present disclosure is achieved. The execution sequence of these steps is not limited herein.

The scope of the present disclosure is not limited to the preceding embodiments. It is to be understood by those skilled in the art that various modifications, combinations, subcombinations and substitutions may be made depending on design requirements and other factors. Any modifications, equivalent substitutions, improvements and the like made within the spirit and principle of the present disclosure is within the scope of the present disclosure.

What is claimed is:

1. A method for training a model based on homomorphic encryption, comprising:
acquiring homomorphic encrypted data in a model training process;
determining a hyperparameter of a model approximation function according to state data present in the model training process; wherein the model approximation function is used for replacing a model original function involved in the model training process and the hyperparameter is a parameter that is associated with the model approximation function and is capable of controlling a model training behavior; and
inputting the homomorphic encrypted data to the model approximation function for calculation to obtain a calculation result, and performing model training according to the calculation result,
wherein the determining the hyperparameter of the model approximation function according to the state data present in the model training process comprises:
inputting the homomorphic encrypted data to the model approximation function adopting a current hyperparameter for calculation to obtain the calculation result; and
acquiring, according to a value range in which the calculation result falls, a hyperparameter corresponding to the value range, and re-determining the hyperparameter corresponding to the value range as the current hyperparameter.

2. The method according to claim 1, wherein the model original function comprises at least one of: a neuron activation function of a neural network, a loss function, or a gradient calculation function.

3. The method according to claim 1, wherein the model original function comprises at least one of: a logarithm function, a power function, a trigonometric function or a piecewise function.

4. The method according to claim 1, wherein the model approximation function comprises a polynomial.

5. The method according to claim 4, wherein the hyperparameter of the model approximation function comprises at least one of: an expansion degree of a polynomial, a variable coefficient, and a number of polynomials in a polynomial combination.

6. The method according to claim 1, wherein the model is a linear model or a neural network model.

7. The method according to claim 1, before the model training process, further comprising a process of determining a matching relationship between the hyperparameter and the calculation result, wherein the determination process comprises:
inputting each of at least two groups of homomorphic encrypted data to the model for test training to obtain a respective test training result,
wherein hyperparameters of model approximation functions used in the test training of the at least two groups of homomorphic encrypted data are different from each other; and
selecting a hyperparameter of a model approximation function that satisfies a training requirement according to the respective test training result of each of the at least two groups of homomorphic encrypted data.

8. The method according to claim 1, wherein the state data comprises a calculation duration of a current round of calculation and/or a number of calculation iterations.

9. The method according to claim 8, wherein the determining the hyperparameter of the model approximation function according to the state data present in the model training process comprises:
if the calculation duration of the current round of calculation in the model training process satisfies a duration condition, determining a candidate hyperparameter whose accuracy priority is lower than an accuracy priority of the current hyperparameter to replace the current hyperparameter.

10. The method according to claim 8, wherein the determining the hyperparameter of the model approximation function according to the state data present in the model training process comprises:
if the number of calculation iterations in the model training process satisfies a number condition, determining a candidate hyperparameter whose accuracy priority is higher than an accuracy priority of the current hyperparameter to replace the current hyperparameter.

11. The method according to claim 1, wherein the model is a distributed model, and the homomorphic encrypted data is a homomorphic encrypted intermediate parameter for interaction between a plurality of model participants in the model training process.

12. An electronic device, comprising:
at least one processor; and
a memory that is in a communication connection with the at least one processor;
wherein the memory stores instructions executable by the at least one processor, and the instructions are executed by the at least one processor to enable the at least one processor to perform:
acquiring homomorphic encrypted data in a model training process;
determining a hyperparameter of a model approximation function according to state data present in the model training process; wherein the model approximation function is used for replacing a model original function involved in the model training process and the hyperparameter is a parameter that is associated with the model approximation function and is capable of controlling a model training behavior; and
inputting the homomorphic encrypted data to the model approximation function for calculation to obtain a calculation result, and performing model training according to the calculation result,
wherein the determining the hyperparameter of the model approximation function according to the state data present in the model training process comprises:
inputting the homomorphic encrypted data to the model approximation function adopting a current hyperparameter for calculation to obtain the calculation result; and
acquiring, according to a value range in which the calculation result falls, a hyperparameter corresponding to the value range, and re-determining the hyperparameter corresponding to the value range as the current hyperparameter.

13. The electronic device according to claim 12, wherein the model original function comprises at least one of: a neuron activation function of a neural network, a loss function, or a gradient calculation function.

14. The electronic device according to claim 12, wherein the model original function comprises at least one of: a logarithm function, a power function, a trigonometric function or a piecewise function.

15. The electronic device according to claim 12, wherein the model approximation function comprises a polynomial.

16. The electronic device according to claim 12, wherein the hyperparameter of the model approximation function comprises at least one of: an expansion degree of a polynomial, a variable coefficient, and a number of polynomials in a polynomial combination.

17. The electronic device according to claim 12, wherein the model is a linear model or a neural network model.

18. The electronic device according to claim 12, wherein before the model training process, the at least one processor is further configured to perform a process of determining a matching relationship between the hyperparameter and the calculation result, wherein the process comprises:
inputting each of at least two groups of homomorphic encrypted data to the model for test training to obtain a respective test training result,
wherein hyperparameters of model approximation functions used in the test training of the at least two groups of homomorphic encrypted data are different from each other; and
selecting a hyperparameter of a model approximation function that satisfies a training requirement according to the respective test training result of each of the at least two groups of homomorphic encrypted data.

19. The electronic device according to claim 12, wherein the state data comprises a calculation duration of a current round of calculation and/or a number of calculation iterations.

20. A non-transitory computer-readable storage medium storing computer instructions, wherein the computer instructions are used for enabling a computer to perform:
acquiring homomorphic encrypted data in a model training process;
determining a hyperparameter of a model approximation function according to state data present in the model training process; wherein the model approximation function is used for replacing a model original function involved in the model training process and the hyperparameter is a parameter that is associated with the model approximation function and is capable of controlling a model training behavior; and
inputting the homomorphic encrypted data to the model approximation function for calculation to obtain a calculation result, and performing model training according to the calculation result;
wherein the determining the hyperparameter of the model approximation function according to the state data present in the model training process comprises:
inputting the homomorphic encrypted data to the model approximation function adopting a current hyperparameter for calculation to obtain the calculation result; and
acquiring, according to a value range in which the calculation result falls, a hyperparameter corresponding to the value range, and re-determining the hyperparameter corresponding to the value range as the current hyperparameter.
